(19) United States
(12) Patent Application Publication
(10) Pub. No.: US 2012/0077426 A1
(43) Pub. Date: Mar. 29, 2012

(54) Variable HVAC Airflow Control

(75) Inventor: Gehard A. Dage, Franklin, MI (US)

(73) Assignee: FORD GLOBAL TECHNOLOGIES, LLC, Dearborn, MI (US)

(21) Appl. No.: 13/310,964

(22) Filed: Dec. 5, 2011

Related U.S. Application Data
(63) Continuation-in-part of application No. 12/359,603, filed on Jan. 26, 2009.

(51) Int. Cl. B60H 1/24

(52) U.S. Cl. 454/75

(57) ABSTRACT

A method and apparatus for controlling air flow into a cabin of a vehicle. The apparatus includes a valve controlling the proportion of fresh air and recirculated air admitted to the cabin, a ventilation fan, and a control module. The control module determines that the full fresh position is selected, detects a fan voltage selected to correspond to a desired air flow rate into the cabin, determines that an expected air flow rate into the cabin at an actual vehicle speed is greater than a desired air flow rate, and causes an actual air flow rate to match the desired air flow rate. The match between desired and actual air flow rates is achieved by maintaining the selected fan voltage and moving the valve to an intermediate position between the full fresh position and the full recirc position.

### CROSS-REFERENCE TO RELATED APPLICATIONS

This application is a continuation-in-part of U.S. application Ser. No. 12/359,603 filed Jan. 26, 2009, the disclosure of which is incorporated in its entirety by reference herein.

### TECHNICAL FIELD

The invention relates to climate control systems for automotive vehicles, otherwise known as heating, ventilating, and air-conditioning (HVAC) systems. More specifically, the invention relates to a system for controlling the ambient air/recirculated air supplied to the passenger compartment of an automotive vehicle.

### BACKGROUND

Automotive vehicle climate control systems commonly include a blower or ventilation fan (typically powered by an electric motor) inducing a flow of ventilation air through ducting into the vehicle passenger compartment, also known as the cabin. The ventilation air supplied to the cabin may be either ambient air from outside the vehicle (fresh air) or air that is recirculated from inside the cabin (recirc air).

Typically, vehicle occupants may select between fresh air and recirc air using a manual, two-position switch. Some climate control systems also include one or more modes in which the selection between fresh and recirc air is made automatically, without the occupant actuating a switch. A known example of such an automatic fresh/recirc selection is when the HIGH or MAX setting of air conditioning (cooling) is selected the system may switch from fresh air to recirc air in order to speed cooling of the cabin.

Control over the speed of the fan and consequently the rate (which may be expressed in either velocity or volume rate) of the air entering the cabin via the ducting may also be manual or automatic. In a manual mode, a vehicle occupant actuates a switch to select between several (commonly from 3 to 5) discrete fan speeds. If the vehicle occupant selects the automatic mode, a controller unit applies programmed logic and memory to vary the fan speed based on factors such a desired temperature, actual temperature, ambient light, etc., with the objective of providing maximum passenger comfort.

A problem previously not solved by climate control systems is to provide a consistent relationship between a desired air flow rate (whether set by a vehicle occupant or by an automatic climate control system) and the actual flow rate of air flow entering the cabin. A ram-air effect through the vehicle ventilation system may result in a higher air flow rate into the cabin than selected when the vehicle is traveling at a relatively high speed and fresh air (as opposed to recirc) is selected. It is known to use a “ram air compensation” technique which calls for a reduction in the fan speed when the vehicle is traveling at higher speed. However, this technique does not solve the problem when a low fan speed is selected and the ram air effect causes a greater then desired air flow rate into the cabin.

This limitation is compounded by the fact that some electric motors used to power the ventilation fan cannot operate at voltages below a certain lower limit without risking overheating, shortened motor life, or other sub-optimal operation. If the minimum operating voltage provides more than the desired air flow rate, the only alternative is be to switch the fan off completely.

### SUMMARY

In a first embodiment, apparatus for controlling air flow into a cabin of a vehicle comprises a valve controlling a proportion of fresh air and recirculated air admitted to the cabin, a variable voltage ventilation fan, and a control module. The valve is movable between a full fresh position and a full recirc position. The control module is operative to determine that the full fresh position is selected, detect a fan voltage selected to correspond to a desired air flow rate into the cabin, determine that an expected air flow rate into the cabin at an actual vehicle speed is greater than a desired air flow rate, and cause an actual air flow rate to match the desired air flow rate. The match between desired and actual air flow rates is achieved by maintaining the selected fan voltage and moving the valve to an intermediate position between the full fresh position and the full recirc position.

In a second embodiment, a method of controlling air flow entering a cabin of a vehicle having a climate control system including a variable speed fan and a fresh/recirc valve is disclosed. The method comprises selecting a full fresh air mode; setting a fan voltage corresponding to a desired air flow rate into the cabin; determining that an expected air flow rate into the cabin at an actual vehicle speed is greater than the desired air flow rate; and, while maintaining the fan voltage setting, moving the fresh/recirc valve to an intermediate position. The intermediate position is selected to reduce the amount of fresh air entering the passenger to achieve an actual air flow rate matching the desired air flow rate.

### BRIEF DESCRIPTION OF THE DRAWINGS

FIG. 1 is a schematic depiction of an automotive vehicle climate control system;

FIG. 2 is a block diagram showing in schematic form the components of the climate control system of FIG. 1;

FIG. 3 is an example of a look-up table of for use in a ram air reduction algorithm; and

FIG. 4 is a graph showing the relationship between fan switch settings and recirc percentages for three vehicle speeds.

### DETAILED DESCRIPTION

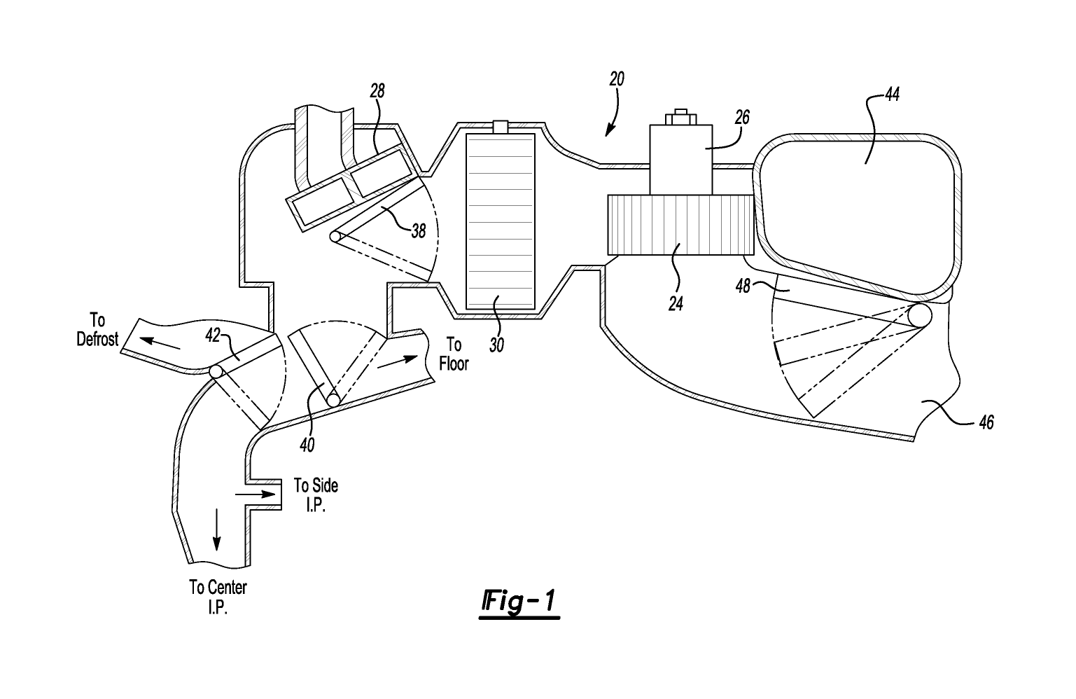

FIG. 1 shows in schematic form the general configuration of an automotive vehicle climate control system. The system includes a system of ducting, generally indicated at 20, for carrying air to outlets or vents in various parts of the vehicle passenger compartment or cabin. A fan or blower 24 is positioned in within the ducting and is powered by a variable-speed electric motor 26. Heating and cooling elements such as a heater core 28 and an air conditioner (AC) evaporator core 30 are disposed downstream from fan 24 and may be activated to heat and/or cool/dehumidify the air supplied to the cabin as desired. A temperature blend door 38 is movable to obtain a desired mixture of heated and cooled/dehumidified air.

Airflow through one or more ducts leading to the cabin is regulated by one or more movable air distribution doors 40, 42 located within the ducting. For example, panel/defrost door 42 is movable to apportion airflow between center and/or side instrument panel vents (not shown) and front/side window defrost vents (not shown), while panel/floor door 40 is movable to apportion airflow between the instrument panel vents and a floor vent (not shown). Doors 38, 40, and 42 are preferably powered by electric motors (not shown) but may be actuated by any appropriate motive means, such as a vacuum system.

A fresh air duct 44 leads to fan 24 from outside the cabin, and a recirc air duct 46 leads to fan 24 from collector vents (not shown) located inside the cabin. A Fresh/Recirculate (F/R) door 48 is movable to control the amount or proportion of fresh air from the outside of the vehicle and recirculated air from the inside of the cabin that is supplied to the cabin by the climate control system. F/R door 48 is shown in solid lines in a maximum recirc position wherein substantially all of the airflow supplied to the cabin is recirculated from inside the cabin and fresh air duct 44 is substantially completely blocked. This maximum recirc position preferably supplies close to 100% recirc air, and will be referred to herein as such, but a ventilation system may be designed such that some amount of fresh air is supplied to the cabin even in maximum recirc.

The lower position of F/R door 48, shown in broken lines, represents the minimum recirc position, also referred to as a “full fresh” position, wherein substantially all of the airflow supplied to the cabin is fresh air, recirc air being completely or nearly completely blocked. This minimum recirc position preferably supplies close to 0% recirc air. However, the full fresh or 0% recirc position does not exclude the case where a small amount of recirc air is supplied to the cabin along with the larger proportion of fresh air.

The center position of F/R door 48 shown in broken lines represents an intermediate position between the maximum and minimum recirc positions. In the intermediate position some desired mixture, proportion, or balance of fresh and recirc air is admitted to the cabin.

Accordingly, F/R door 48 functions as a valve that controls the balance or proportion of fresh air versus recirc air admitted to the cabin through the ducting system 20.

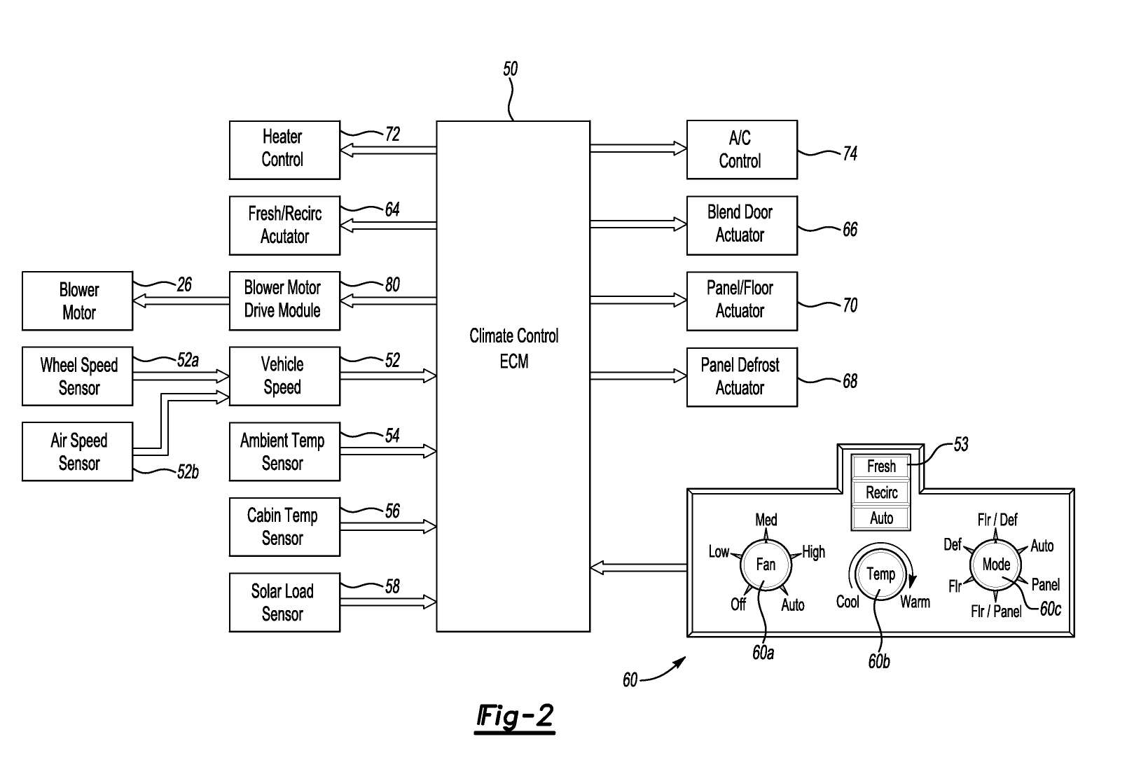

Referring now to FIG. 2, the climate control system further includes a programmable electronic control module (ECM) generally designated 50. ECM 50 receives inputs from one or more sensors including (but not limited to) a vehicle speed sensor 52, an ambient (external to the vehicle) temperature sensor 54, a cabin temperature sensor 56, and a solar load sensor 58. A control assembly 60 include knobs or selectors such as fan control 60a (labeled FAN), temperature control 60b (TEMP), and mode control 60c (MODE).

Control selectors 60a-c are used by the vehicle operator to select desired climate/comfort setting and provide input commands to the ECM 50. While control assembly 60 is depicted in FIG. 2 as comprising knobs or dials that are manually rotated by an operator, it may also comprise any combination of push-buttons, touch-screen controls, a voice-actuated control system, or any appropriate means to allow operator selection of the various control settings.

Control assembly 60 may also include, as is well known in the art, a Fresh/Recirc select switch 53 that allows an occupant to manually select between 100% fresh air (minimum recirc), 100% recirc air (maximum recirc), and an AUTO setting.

Fan control 60a allows a vehicle occupant to select a desired air flow rate by setting a fan speed to, for example, OFF, LOW, MED, HIGH, or AUTO. At the LOW, MED, and HIGH settings, a specific voltage is supplied to blower motor 26, these voltage setting corresponding to the respective desired air flow rates. At the AUTO setting, the voltage supplied to fan motor 26 is controlled by ECM 50 (to be described in more detail below) as necessary to achieve desired conditions.

Mode selector 60c allows a vehicle occupant to select the location of the vents to which air supplied by fan 24 is directed. PANEL, FLOOR, FLR/PANEL, DEF, FLR/DEF, and AUTO settings are examples of mode settings commonly used in the automotive industry, and other possibilities and combinations exist.

ECM 50 may be a microprocessor-based controller having a central processing unit, internal memory such as RAM and/or ROM), and associated inputs and outputs communicating across a/the bus. ECM 50 may be a portion of a central vehicle main control unit or a stand-alone unit. The controller may include various processing units which may be incorporated as separate devices or as an integral part of the controller. ECM 50 may, as is described in greater detail below, control the various motors and actuators of the climate control system based upon the various sensor and control inputs and in accordance with programmed logic or algorithms.

ECM 50 controls a fresh/recirc actuator 64, a blend door actuator 66, a panel/defrost actuator 68, and a panel/floor actuator 70, these actuators respectively moving F/R door 48, temperature blend door 38, panel/defrost door 42, and panel/floor door 40. Actuators 64, 66, 68, and 70 are preferably electric motors, but may alternatively be any appropriate motive means, such as a vacuum system.

ECM 50 may also provide control signals to a heater controller 72 and an air conditioner controller 74 which control the amount of heating and cooling delivered by heater core 28 and AC core 30 respectively.

The ECM 50 controls fan motor 26 through a fan motor drive module 80 in response to the setting selected by the operator using fan control 60a. In the OFF mode the ECM 50 may command fresh/recirc actuator 62 to move F/R door 48 to the 100% recirc position to avoid any ram air flow into the cabin when the vehicle is in motion. When an air flow rate (fan speed) is selected by an occupant using fan control 60a, the ECM 50 sends a signal to the module 80 to set the voltage powering fan motor 26. The fan voltage to be used may depend on the operating mode selected and may be contained in look-up tables in the memory of ECM 50.

When fan selector 60a is set to the AUTO setting, ECM 50 applies preprogrammed logic and memory to determine and direct, based upon sensor and operator control inputs, the correct temperature, mode, and fan speed required to achieve maximum comfort in the cabin. When such an automatic mode is selected, fan motor drive module 80 may vary the fan speed by adjusting the voltage powering fan motor 26 anywhere between zero volts (fan off) and the maximum system voltage (fan full speed).

Typical passenger vehicles, at the time of this writing, utilize a 14 volt (14V) electrical system so, for the example discussed in this disclosure, 14V shall be considered to equate to fan full speed. Some fan motors cannot operate properly at voltages below a certain lower limit. In the example system described herein, the designed minimum operating voltage for the fan motor is assumed to be 4 volts.

When F/R door 48 is in the fresh position, as may be selected by a vehicle occupant or by an automatic climate control algorithm executed by ECU 50, the air flow rate (which may be measured and expressed as velocity and/or volume rate) of air entering and passing through ducting system 20 is at least partially dependent upon the speed of the vehicle through the air mass outside the vehicle. It may be assumed that the vehicle airspeed is equal to the vehicle's ground speed as detected by wheel speed sensors 28a used by the vehicle speedometer. However, a more accurate airspeed could be measured if the vehicle is equipped with an appropriate airspeed sensor 52b. An airspeed sensor could also be located within the climate control system ducting at a point where it would give an accurate indication of the velocity of the air entering or about to enter the cabin.

At relatively low fan speed settings the ram air effect of outside air entering through fresh air duct 44 may result in the air flow into the cabin being greater than that called for by ECM 50. For a particular vehicle climate control system there is a lower vehicle speed boundary below which the ram air effect does not significantly affect the cabin air flow but above which the actual air flow rate will be greater than the desired rate, as established by the fan speed setting. The lower vehicle speed boundary (hereinafter referred to as the critical speed) depends primarily on the internal configuration of the ducting and the amount of resistance to air flow provided by that configuration. Among the determining factors of the critical speed may be any bends and/or constrictions in the ducting and the size, type, and configuration of AC evaporator core 2. The critical speed for a particular model of vehicle is most accurately determined by road and/or wind tunnel testing. For the present example, the critical speed is assumed to be 40 kilometers per hour (KPH), and the graphs and tables are for a vehicle travelling at or above that speed.

Under the set of conditions stated above, ECM 50 executes an algorithm or program that maintains the voltage supplied to fan motor 26 at the level previously selected and directs F/R door 48 to move away from the full fresh (minimum recirc) position and to an intermediate position that reduces or eliminates the undesirable ram air effect. The intermediate position directed by ECM 50 is that which, at the fan voltage setting and the current vehicle speed, makes the actual air flow into the cabin match, as closely as is practical, the desired air flow rate corresponding to the fan voltage setting. F/R door 48 thus will preferably assume a range of different intermediate positions (between full fresh and recirc) as the vehicle speed changes.

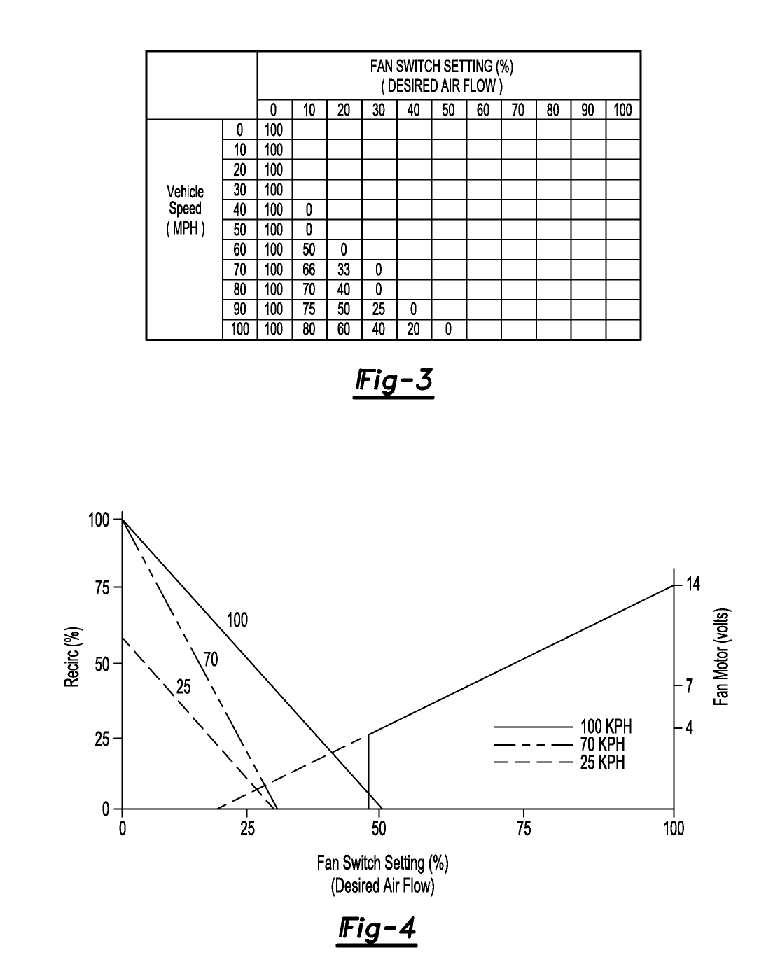

FIG. 3 is a look-up table such as may be used in the program or algorithm applied by ECM 50 to schedule the position of F/R door 48. In FIG. 3, the vertical axis is vehicle speed (road speed or airspeed) in kilometers per hour (KPH), and covers a normal operating range of from 0 KPH to 90 KPH. The horizontal axis is the selected fan switch setting (reflecting the desired air flow rate) and ranges from 0% (fan off) to 100% (maximum air flow requested).

The values populating the cells of the FIG. 3 table are the F/R door 48 position commanded by ECM 50 in order to achieve the desired air flow rate at each given speed point or range. The F/R door positions are expressed in % (percent) recirculated air, with 0% corresponding to the door positioned to admit full or maximum fresh air (F/R door 48 shown in dashed lines in FIG. 1) and 100% corresponding to the door positioned to admit full or maximum recirc air (F/R door 48 shown in solid lines in FIG. 1). Empty cells in the FIG. 3 table are 0% recirc.

For example, at a speed of 100 KPH and with the fan switch set at 30%, ECM 50 commands F/R door 48 to an intermediate position corresponding to 40% recirc air. At the 40% recirc position, F/R door 48 blocks a substantial amount of the fresh air that would be entering the cabin through fresh air duct 44 if the F/R door 48 remained at 0% recirc. Accordingly, the 40% recirc setting reduces the ram air effect caused by the vehicle travelling at 100 KPH so that the desired air flow rate is achieved.

If the fan switch setting is increased to 50%, indicating a greater desired air flow rate into the cabin, ECM 50 commands F/R door 48 to 0% recirc air, allowing full fresh air to the cabin.

As may be seen from FIG. 3, at speeds below a lower speed boundary of 60 KPH it may not be necessary to set F/R door 48 at a position other than 0% recirc (full fresh), because the ram air effect is not significant below that speed. At the other end of the speed range, there may be an upper speed boundary at which F/R door 48 is commanded to 100% recirc position at all fan speed settings. This upper speed boundary is not reflected in FIG. 3.

FIG. 4 shows, on the left side of the graph, the relationship between fan switch setting and the scheduled position of the door to achieve an actual air flow rate approximately equal to the desired flow rate. Curves for three vehicle speeds are shown: 25 KPH, 70 KPH, and 100 KPH. Although all three the curves show a linear relationship between the two axes, this is by way of example only, and the schedule may be non-linear to achieve an actual flow rate close to the desired air flow rate. The three vehicle speed cures and not necessarily intended to show the data presented in tabular form in FIG. 3.

For the 70 KPH and 100 KPH cases, the curves show that F/R door 48 is at 100% recirc when the fan switch is OFF. For the 25 KPH case, however, F/R door 48 may not need to be set to 100% recirc to avoid an undesirable ram air flow.

The right side of the FIG. 4 graph shows that as the fan switch setting is reduced from 100%, the electrical power supplied to the fan motor ramps downward from the maximum operating value of 14 volts to a minimum of 4 volts, before dropping to zero. The dashed line that continues sloping downward toward the x-axis indicates the case where a fan motor does not have a minimum operating voltage, but rather can have its voltage reduced smoothly to zero.

It should be noted that the fan motor voltage graph in FIG. 4 is applicable for all vehicle speeds, and that only the F/R door position needs to be changed in order to make the actual air flow rate match the desired rate.

FIGS. 3 and 4 may relate to a climate control system operating in an automatic mode so that fan speed may be continuously and infinitely varied as directed by the comfort control algorithm(s) run by ECU 50. The method, however, can be practiced with the climate control in a mode where the vehicle occupant selects a fan speed manually.

For example, if the manual fan speed control has three discrete setting (LOW, MEDIUM, HIGH) the F/R door schedule may require that the F/R door 48 be at other than 0% recirc only at the LO fan setting. If more than three discrete fan speed/voltage settings are available for selection by a vehicle occupant, the F/R door 48 position may be at other than 0% recirc at two or more of the lower fan speeds.

While the best mode for carrying out the invention has been described in detail, those familiar with the art to which this invention relates will recognize various alternative designs and embodiments for practicing the invention as defined by the following claims.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for controlling air flow into a cabin of a vehicle, comprising:
a valve controlling a proportion of fresh air and recirculated air admitted to the cabin, the valve movable between a full fresh position and a full recirc position;
a variable voltage ventilation fan; and
a control module operative to:
determine that the full fresh position is selected;
detect a fan voltage selected by an occupant;
determine that an expected air flow rate into the cabin at an actual vehicle speed is greater than a desired air flow rate corresponding to the selected fan voltage; and
cause an actual air flow rate to match the desired air flow rate by 1) maintaining the selected fan voltage and 2) moving the valve to an intermediate position between the full fresh position and the full recirc position.

2. The apparatus of claim 1 wherein the valve comprises a fresh/recirc door operable to substantially block a recirc air duct when in the full fresh position and to substantially block a fresh air duct when in the full recirc position.

3. The apparatus of claim 1 wherein the control module receives the vehicle speed input from a wheel speed sensor.

4. The apparatus of claim 1 wherein the control module receives the vehicle speed input from an air speed sensor.

5. The apparatus of claim 1 wherein the fan has an automatic voltage control setting.

6. The apparatus of claim 1 wherein the ventilation fan has a manual voltage control setting.

7. The apparatus of claim 1 wherein the control module uses at least one look-up table to determine the valve position.

8. The apparatus of claim 1 wherein the control module positions the valve to achieve a substantially linear relationship between the fan speed input and an actual air flow rate entering the cabin.

9. The apparatus of claim 1 wherein the fan has a minimum operating voltage greater than zero volts and the control module is further operative to:
detect that the expected air flow rate at the current speed is greater than the actual air flow rate that can be achieved with the fan set to the minimum operating voltage; and
turn the fan voltage to zero.

10. A method of controlling air flow entering a cabin of a vehicle having a climate control system including a variable speed fan and a fresh/recirc valve, the method comprising:
selecting a full fresh air mode;
setting a fan voltage corresponding to a desired air flow rate into the cabin;
determining that an expected air flow rate into the cabin at an actual vehicle speed is greater than the desired air flow rate; and
while maintaining the fan voltage setting, moving the fresh/recirc valve to an intermediate position reducing the amount of fresh air entering the passenger to achieve an actual air flow rate matching the desired air flow rate.

11. The method of claim 10 wherein the fresh/recirc valve is positioned to achieve a substantially linear relationship between fan voltage and actual air flow rate at the actual vehicle speed.

12. The method of claim 10 wherein the fan voltage is set by a manual fan control.

13. The method of claim 10 wherein the fan voltage is set by an automatic fan control.

14. The method of claim 10 wherein the positioning step comprises using at least one look-up table stored in a control module.
